(19) United States
(12) Patent Application Publication
(10) Pub. No.: US 2021/0090109 A1
(43) Pub. Date: Mar. 25, 2021

(54) Messaging, Protocols and APIs for Dynamic Inventory Provision by One-Time Codeshares Across Platforms

(71) Applicant: eBay Inc., San Jose, CA (US)

(72) Inventors: Tatjana Vlahovic, San Jose, CA (US); Gail Anna Rahn Frederick, Portland, OR (US)

(73) Assignee: eBay Inc., San Jose, CA (US)

(21) Appl. No.: 17/110,787

(22) Filed: Dec. 3, 2020

Related U.S. Application Data
(63) Continuation-in-part of application No. 16/235,633, filed on Dec. 28, 2018.

(51) Int. Cl. G06Q 30/02; H04L 29/08; G06Q 30/06

(52) U.S. Cl. CPC G06Q 30/0212; G06Q 30/0633; H04L 67/306

(57) ABSTRACT

Described are computing systems and methods, computer program products, and application programming interfaces (APIs) or web requests that facilitate code sharing between operators of e-commerce platforms. In accordance with various embodiments, a codeshare principal shares its inventory and other functionality with a codeshare partner to thereby expand its customer base. Requests from the partner to the principal include identifiers of the partner as well as the partner's user, allowing the principal to track its extended customer base and tailor restricted offers to users of affiliated partner systems.

### RELATED APPLICATIONS

This application is a continuation-in-part and claims priority to U.S. patent application Ser. No. 16/235,633 entitled “Code Sharing in e-Commerce” and filed Dec. 28, 2018, the entire disclosure of which is incorporated by reference.

### TECHNICAL FIELD

The present disclosure relates to computing systems and methods, computer program produces, and application programming interfaces (APIs) that facilitate code sharing between multiple electronic marketplaces, web sites, or any other commercial actors or e-commerce platforms.

### BACKGROUND

Code sharing—a term used by the airline industry—involves the cross-marketing of products or services between two or more providers (e.g., merchants, companies, etc.) pursuant to some contractual business arrangement. For example, two airlines may both list the same flight (operated by one of them), each under their own respective airline flight code. By cross-listing each other's flights using code sharing, airlines operating flights between the same departure and destination airports can increase the perceived frequency of service along that route; airlines operating different ones of two connecting flights can provide clearer routing for their customers; and airlines servicing different geographic regions can gain exposure in the respective markets in which they do not themselves operate. An opportunity exists to consider technical ways of integration of this paradigm to other platforms and sites.

### SUMMARY

Techniques for restricted codeshares are described that overcome the challenges of conventional techniques by extended customer base and tailor restricted offers to codeshare principal's partners and their end users, thus extending the customer base of codeshare principals. In one example, a principal system generates data based on monitoring a plurality of partner systems configured to pass inventory involving a plurality of items in succession from the principal system. When the principal system receives a listing of an item, a determination is made as to which of the partner systems is to output the listing based on the data, where the determined partner system does not include the item as available via the determined partner system. Based on the determination, the principal system generates a restricted offer message. The restricted offer message configures the determined partner system to include digital content configured for rendering in a user interface. Responsive to receiving the restricted offer message, the partner system renders the digital content, the digital content including listing access data for the item and a description of the item. This digital content is displayed via a user interface, such as the user interface of a client device of an end user. The listing of the item of the restricted offer message (e.g., a one-time offer message) can be accessed via the listing access data of the digital content, redirecting the user to the principal system for conversion, such as a purchase of the item. If a user purchases the item, the principal system receives a purchase request, where the purchase request may include a codesharing identifier that identifies the partner. If a user does not purchase the item of the restricted offer message, the principal system configures the partner system to make the digital content unavailable to end users, thus making the listing inaccessible.

In this way, a codeshare principal is enabled to efficiently tailor restricted codeshares to the codeshare principal's partners and their end users, thus extending the customer base of codeshare principals. Further discussion of these and other examples is included in the following sections and shown in corresponding figures.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion. The appended drawings illustrate, by way of example and not of limitation, various embodiments of systems, methods, and computer program products implementing the inventive subject matter.

FIG. 1 is an illustration of an environment in an example implementation that is operable to employ techniques for restricted codeshares described herein.

FIG. 2 depicts a system in an example implementation showing operation of a principal system of FIG. 1 in greater detail as generating data based on monitoring a plurality of partner systems, and a restricted offer message.

FIG. 3 is a flow diagram depicting a procedure in an example implementation in which a restricted offer message is generated based on determining which of the plurality of partner systems is to output a received listing of an item, the restricted offer message configuring the determined partner system to include digital content configured for rendering in a user interface.

FIG. 4 is a flow diagram depicting a procedure in an example implementation of a server system that may be operated by, on behalf, or under the control of a codeshare principal.

FIG. 5 depicts a system in an example implementation showing operation of a partner system of FIG. 1 in greater detail.

FIG. 6 is a flow diagram depicting a procedure in an example implementation in which a partner system renders digital content responsive to receiving a restricted offer message and displays the digital content in a user interface.

FIG. 7 depicts a system in an example implementation in which a client device receives, via a user interface displaying digital content, listing access data to access a listing of a restricted offer message.

FIG. 8 is a block diagram illustrating actors within a code sharing ecosystem according to example embodiments.

FIG. 9 is a block diagram illustrating communications between the actors within a code sharing ecosystem according to example embodiments.

FIG. 10 is a flow chart depicting various acts performed by a codeshare partner to share user behavioral data with a codeshare principal, in accordance with various embodiments.

FIG. 11 is a process flow diagram depicting the transactional flow of a two-buyer transaction in accordance with various embodiments.

FIG. 12 is a process flow diagram depicting a partner-mediated informational flow between a codeshare partner and an end customer in accordance with various embodiments.

FIG. 13 is a flow chart of an example method performed by a codeshare principal in tailoring its response to a request based on user preferences, in accordance with various embodiments.

FIG. 14 is a schematic diagram illustrating sources of user and partner behavioral data, in accordance with various embodiments.

FIG. 15 is a block diagram illustrating software components of a codeshare principal's server system in accordance with various embodiments.

FIG. 16 is a diagrammatic representation of a machine in the example form of a computer system within which a set of instructions for causing the machine to perform any one or more of the methodologies or embodiments of techniques discussed herein may be executed.

### DETAILED DESCRIPTION

### Overview

In the following description, reference will be made to specific example embodiments for carrying out the inventive subject matter. Examples of these specific embodiments are illustrated in the accompanying drawings. It will be understood that these examples are not intended to limit the scope of the claims to the illustrated embodiments. On the contrary, they are intended to cover alternatives, modifications, and equivalents as may be included within the scope of the disclosure. In the following description, specific details are set forth in order to provide a thorough understanding of the subject matter. Embodiments may be practiced without some or all of these specific details.

The present disclosure relates to various technical aspects of implementing code sharing arrangements. For clarity, various embodiments are described from the perspective of a primary actor, herein the “codeshare principal,” that offers its products and/or services through one or more codeshare partners. It is to be understood, however, that codeshare arrangements may be (although they need not be) reciprocal, allowing the roles of codeshare principal and codeshare partner to be reversed between a given pair of codeshare parties. In various embodiments, the codeshare principal provides a platform that exposes certain functionalities to its codeshare partner(s) and their respective platforms. Without limitation, such functionalities may include inventory feeds and inventory checks, transactional functions for payment and shipping arrangements, and/or search and discovery features, for example. A “platform,” as understood herein, may be or include a server, web site, mobile app, voice interface, phone ordering system, or other technical implementation. In some embodiments, the codeshare principal's platform is implemented by a server (including one or more server computers), operated by, on behalf, and/or under the control of the codeshare principal, that exposes some of the principal's functionality, e.g., via a web site and/or one or more APIs (e.g., web APIs). As an example, AMAZON®, ETSY®, ALIIBABA®, or others could integrate code sharing to a web site to enhance partner integration. Equally, this technique may be used by web search providers such as a GOOGLE® site in conjunction with web search offerings, a NETFLIX® site in relation to media offerings, etc. The codeshare partners can access this functionality via (e.g., API) requests to the server.

Code sharing may be particularly suited to e-commerce platforms. For instance, the Internet has made mass amounts of inventory available to online consumers. However, due to the quantity of inventory made available via the Internet, online consumers have difficulty surfacing items of interest. Conventional techniques for finding, locating, and interacting with a desired item or service via the Internet inefficiently uses network and computational resources due to the proliferation of mass amounts of inventory available to online consumers. E-Commerce platforms and large suppliers of inventory are subject to these inefficiencies, despite their continued advances in computing technologies to enable their various accessible goods and services to be surfaced to client devices. As a result, client devices may not surface digital services of interest, and may not be leveraged in many scenarios. Accordingly, instead of shopping at large online providers of inventory, such as eBay, online consumers increasingly prefer to shop via smaller providers of inventory, where the inventory is curated for target audiences. This prevents large online providers of inventory from extending the full reach of their existing inventory, resulting in missed opportunities to better surface inventory of interest to interested consumers.

Similarly, an online seller prevented from directly transacting with end customers in a certain geographic region can gain marketing exposure to those end customers by partnering with a seller operating in that geographic region, channeling merchandise through the partner. Similarly, a boutique offering one type of merchandise (e.g., dresses) may complement its offering by cross-listing and purchasing merchandise in related product categories (e.g., jewelry, accessories) from a partner for resale to its own customers. Thus, code sharing arrangements allow a provider to effectively expand its customer base through transactions mediated via a codeshare partner while also making otherwise unavailable listings accessible to end users. Restricted codeshares also enable codeshare principals to test user interest of end users of particular codeshare partners in regard to different types of inventory, thus receiving valuable data on inventory demand.

Accordingly, to overcome these problems, to expand awareness of inventory that are made available by principal systems, and to make inventory accessible to client devices, techniques for restricted codeshares are leveraged. Listings and items of inventory made available include product offerings (e.g., new, used, tangible, intangible, digital, and so forth), subscription enrollment, real property, property rentals, service offerings (e.g., house cleaning, babysitting, landscaping, etc.), classified offerings, and so on.

The code sharing techniques described herein confer various technical advantages to computers and data centers using them. For example, by allowing use of a code sharing identifier, the number of listings of items may be filtered or reduced, and better curated. This improves network bandwidth because less data is sent, and it improves the efficiency of processors because less data is processed. Still further, less memory, storage need be used in processing fewer items and listings of items.

Still further, by gathering data, such as behavioral data, associated with a partner and/or a user, there is a technical advantage of improved data accuracy in presentation of items for an end user of a partner system. For example, by automatically determining interests based on behavioral interaction with a web site or other platform, it is more likely that a user will find an item being sought efficiently and quickly, and more likely that a user does not select a non-optimal item. It follows, of course, that if the user is more efficient in selection of an item, fewer processor cycles and computational resources are used in processing results.

In addition, the code sharing techniques described herein include use of device fingerprints. The use of fingerprints, which are not easy to spoof, confer a technical advantage to systems by improving the security and integrity of transactions. Use of device fingerprints of a user device, or partner device, may improve security of systems. By including various details of systems, including hardware details, operating system, application install details, a fingerprint becomes very difficult to spoof.

APIs are, conceptually, software intermediaries that allow two software applications to communicate with each other. In general, APIs may take the form of specifications and/or software implementations of routines, classes, class methods, communication protocols, and the like that expose components of the API provider's software system and functionality in well-documented services to internal, external partner, or anonymous developers. Web APIs, in particular, usually include a set of specifications for request messages along with the definition and structure of response messages that facilitate interactions between a server and client applications using its assets. In the context of code sharing as discussed herein, APIs provide specifications that enable applications executing on a partner's computing system to interface with and utilize some of the software-implemented functionality of the principal's server.

Code sharing in accordance with various embodiments goes beyond conventional codeshare arrangements by facilitating and taking advantage of information sharing about end customers (with the end customers' and partners' authorization, as described further below). For example, a codeshare partner may, in addition to facilitating an indirect transaction between an end customer and a codeshare principal (e.g., mediating a purchase of a product or service by the end customer from the codeshare principal), pass on information about that end customer to the principal. The information may include at least a unique identifier of the end customer that persists across repeat transactions or requests involving the same end customer, enabling the codeshare principal to properly attribute requests and transactions to individuals (although the real-world identities of these individuals may remain hidden) and thereby obtain an accurate count of its complete customer base and recognize, e.g., new or returning customers. The information shared with the codeshare principal may also include user behavioral data, such as browsing and/or purchase histories recorded by the codeshare partner. Recording and aggregating request/transactions attributable to and/or behavioral or other additional data about a given end customer can give the codeshare principal the ability to tailor its response to subsequent requests to the end customer, and to curate restricted codeshares for partner systems of the codeshare principal.

Apart from information about individual end customers, the codeshare partner may also transmit statistical or aggregate behavioral data about its customers and/or data about its own activities, such as one or more categories of products/services offered by the codeshare partner, sales data for items within the category and for items outside the category, and/or marketing data about a presentation of item listings the codeshare partner received from the codeshare principal. With permission and consent received, partner behavioral information may also be recorded, such as commonly queried categories of interest from a partner, or frequently browsed items from a partner site (or other partner platform), etc. Such information may be recorded by the codeshare principal in association with a unique identifier of the codeshare partner, and used to tailor the codeshare principal's responses to requests received from the codeshare partner.

In various embodiments, to facilitate the above-described information sharing, each request from a codeshare partner to the codeshare principal's server may include a unique identifier of the codeshare partner (hereinafter also the “code sharing identifier”), a unique identifier of the end customer (or end user) on behalf of which the codeshare partner makes the request (herein also the “user identifier”), or both. The code sharing identifier may be assigned to the codeshare partner in the course of setting up the code sharing arrangement. The user identifier may be based, e.g., on an email address, telephone number, or device fingerprint of an electronic device used by the end customer, which may be used in encoded form to protect the end customer's identity. The codeshare principal can use the code sharing identifiers and user identifiers to track and aggregate requests and transactions per partner and per user, e.g., by creating or updating partner and user data records associated with the respective identifiers based on requests or transactions. Further, subsequent to the first request including a particular user identifier and code sharing identifier, content sent by the codeshare principal in response to further requests including the same user identifier and/or code sharing identifier can be determined based on the respective user data record and/or partner data record.

In one embodiment, a codeshare principal system makes inventory available to a partner system, via a restricted codeshare, in order to increase awareness of the partner system's accessible listings of items via digital content. Examples of principal systems include eBay®, Amazon®, Alibaba®, Walmart®, and so forth. Examples of partner systems include Catch®, eBay Classifieds Group®, and so forth. Examples of digital content include digital images, animations, audio content, multimedia content, webpages, social media posts, non-fungible tokens, and so forth. The digital content may be generated by a principal system, a partner system, or some other entity. The restricted codeshare may be one-time, or restricted in other ways, such as the duration of its availability, users that the restricted codeshare is available to, and so forth.

Initially, a server system that may be operated by, on behalf, or under the control of a codeshare principal, monitors a plurality of codeshare partner systems in a hierarchy, which are configured to pass inventory involving a plurality of items in succession from the principal system. The passing of inventory is controlled by the system in a dynamic and curated manner based on monitored and generated data. The hierarchy of the curated intermediary systems mutually benefit from this arrangement, while also providing end users with additional items of their curated interest. Based on monitoring the plurality of partner systems (e.g., the item listings, user data, partner data of the partner systems, subscription data of the partner systems, and so forth), the principal system generates data. When the principal system receives a listing of an item, the principal system determines, based on the generated data, which of the plurality of partner systems is to output the listing based on the data, the determined partner system not including the item as available via the determined partner system. In one example, this is performed using machine learning (e.g., a neural network) that is trained using training data that describes user characteristics, characteristics of goods or services, and “where” in the hierarchy the goods or services are converted (e.g., by which partner system). The system, upon receipt of a new listing, may then make a determination in real time, even for items not previously encountered, using the trained model. In this manner, the inventory made available through the restricted codeshare is curated, filtering listings of items that would be of greatest interest to end users of the determined partner system, assessing that a partner system in the hierarchy of partners is suitable. This determination may be optimized by a model or an algorithm developed to optimize or increase sales, conversions, user interaction, shares, and impressions, which may be based on historically collected data. This determination may also involve subscription data provided by the intermediaries. Based on this determination, the principal system generates a restricted offer message, the restricted offer message configuring the determined partner system to include digital content configured for rendering in a user interface. The restricted offer message may also configure the determined partner system in a variety of ways. The restricted offer message may also include instructions such as the duration of the restricted offer, resource allocation (interchangeably, “payment”) terms, and so forth. Responsive to receiving a restricted offer message from a principal system, the partner system renders digital content. The digital content may be configured for communication over a network, for rendering in a user interface, and so forth. The digital content may also include a description of the item based on the restricted offer message, listing access data, and so forth. Examples of listing access data include a URL, a QR code, and so forth. The digital content may be selectable by an end user to access the listing of the item of the restricted offer message. By accessing the listing via the listing access data of the digital content, an end user is redirected to the principal system (or alternatively, a different partner system in the hierarchy of partners, where the listing of the item is available via the different partner system). The different partner system may be more proximate or distal to the principal system in the hierarchy of partner systems. After the determined partner system receives the restricted offer message, the principal system is notified of events associated with the restricted offer message, such as actions taken by the end user, activity of the partner system, and so forth. Receiving such notifications initiate actions, such as recording the actions, configuring the determined partner system to make the digital content unavailable for rendering in the user interface, providing attribution to the determined partner system, and so forth. Attribution may be provided due to an affiliated code sharing identifier (e.g., a token, symbol, unique set of alphanumeric values, and so forth) that identifies the determined partner system.

In the instance where an end user purchases the item of the listing of the restricted message offer, the principal system receives a purchase request for the item, processes the purchase request, and rescinds the restricted offer message. The restricted offer message may also be rescinded, in one implementation, responsive to receiving notification has accessed the listing of a restricted offer message, such that the digital content is made unavailable to other users. The principal system may also receive transactional compensation, such as a resource allocation or a payment. The purchase request, in one implementation, includes identifying information, such as the code sharing identifier of the partner, and so forth. The payment and purchase request are processed by the principal system, such that information such as the transaction, code sharing identifier, and so forth are properly recorded, and that the system (e.g., principal system) holding the item of the restricted offer message in inventory properly ships the item. Event information from each restricted codeshare is received by the principal system such that the restricted codeshares offered in the future continue to be dynamically curated. The item may be shipped after processing the purchase request from the principal or a third-party seller to the codeshare partner, and then forwarded by the codeshare partner to an end user that purchased the item of the restricted codeshare.

In one embodiment, a method performed by a codeshare principal's server system (e.g., by one or more processors of the server system that execute instructions stored in a computer-readable medium) involves receiving a request that includes a code sharing identifier associated with a partner, a user identifier, and a user query criterion, and, in response to the request, determining a category associated with the code sharing identifier, determining an item within the category based on a preference associated with the user identifier and the user query criterion, and returning the item in a response to the request. The item within the category may be determined by determining, based on the preference associated with the user identifier and the user query criterion, two or more items at least one of which is associated with the category and at least one of which is not associated with the category, and selecting, among the two or more items, an item associated with the category. The response may include a ranking or recommendation of one or more items based on the code sharing identifier, and optionally further based on the user identifier.

The method may further include receiving, prior to the request, a call that includes user behavioral data about a user associated with the user identifier, the user behavioral data collected at a partner platform (e.g., a partner site) associated with the code sharing identifier, wherein the preference associated with the user identifier is based at least in part on the user behavioral data; the user behavioral data may include any one of user click data, user telemetry data, and/or user browse data on the partner platform. Alternatively or additionally, the method may include receiving, prior to the request, a call that includes partner behavioral data about the partner associated with the code sharing identifier, wherein the item within the category is determined further based on the partner behavioral data; the partner behavioral data may include any one of aggregate behavioral data about multiple users on a partner platform, marketing data about a presentation of items received by the partner from the server system the partner platform, or partner sales data for items within the category and for items outside the category.

In the following discussion, an example environment is first described that may employ the techniques described herein. Example procedures are then described which may be performed in the example environment as well as other environments. Consequently, performance of the example procedures is not limited to the example environment and the example environment is not limited to performance of the example procedures.

### Example Environment

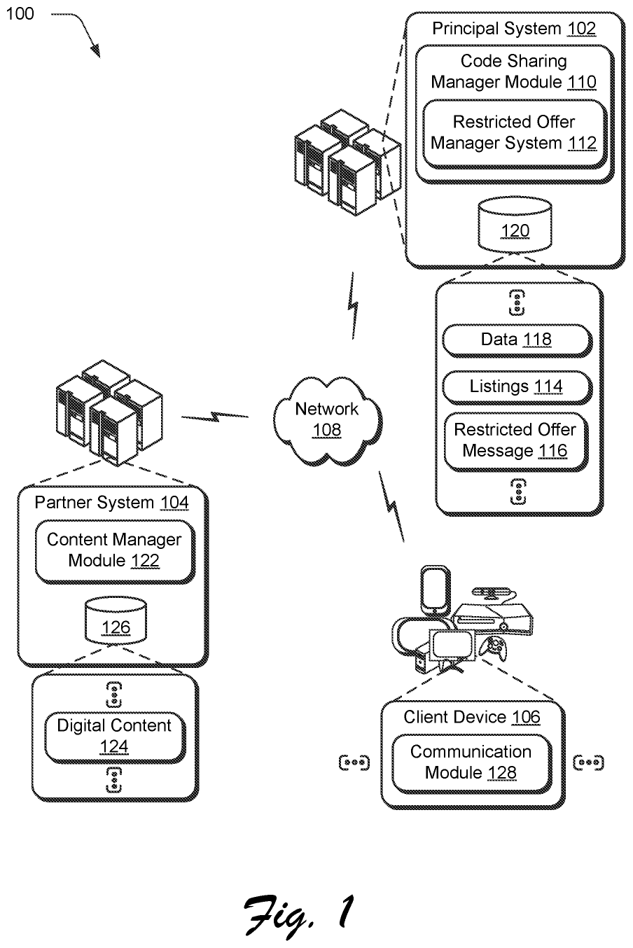

FIG. 1 is an illustration of a digital medium environment 100 in an example implementation that is operable to employ techniques for restricted codeshares described herein. The illustrated environment 100 includes a principal system 102, a partner system 104, and a client device 106 that are communicatively coupled, one to another, via a network 108.

The principal system 102 includes a code sharing manager module 110 including a restricted offer manager system 112. The principal system 102 includes an inventory of listings 114 of items, such as goods and services for purchase or reservation, software subscriptions, digital content, physical items, and so forth. The principal system 102 allocates restricted codeshares via restricted offer messages 116 to partner systems 104, for the listings 114. Data 118 generated based on monitoring the partner systems, the restricted offer messages 116, and the listings 114 are stored in a storage device 120 of the principal system 102.

The partner system 104 includes a content manager module 122. The partner system 104 provides digital content 124 accessible by computing devices, such as digital images, animations, audio content, multimedia content, a webpage, a social media post, and so forth. The digital content 124 is stored in a storage device 126 of the partner system 104. The partner system 104 may be configured in a variety of ways, such as to support instant messaging, social network communications (e.g., ‘shares’ or posts), electronic messages, email, and so forth.

The client device 106 is a computing device that makes the digital content 124 available for interaction with via its user interface, and may be used to access or utilize the listings 114 made accessible by the digital content 124 displayed by the partner system 104, and allocated as a restricted codeshare by the principal system 102. The client device 106 includes a communication module 128 that is implemented at least partially in hardware of the client device to interact with the digital content and the listings made accessible via the network.

Computing devices that implement these devices and systems may be configured in a variety of ways. A computing device, for instance, may be configured as a desktop computer, a laptop computer, a mobile device (e.g., assuming a handheld configuration such as a tablet or mobile phone), and so forth. Thus, a computing device may range from full resource devices with substantial memory and processor resources (e.g., personal computers, game consoles) to a low-resource device with limited memory and/or processing resources (e.g., mobile devices). Additionally, although a single computing device is depicted and described in some instances, a computing device may be representative of a plurality of different devices, such as multiple servers utilized by a business to perform operations “over the cloud” for the services of the principal system 102 and the partner system 104.

The client device 106 is configured to communicate with computing devices via the network 108 by using the communication module 128. The communication module 128 also enables the client device 106 to communicate with the principal system 102 and the partner system 104. Communications supported by the communication module 128 may be configured in a variety of ways. Examples of configurations of communications include instant messages, posts, emails, text messages, and other types of user interaction that may be communicated via the network 108.

In some instances, users may wish to share information about the digital content 124 they have located that is accessible via the network 108. The digital content 124 may be configured in a variety of ways, such as webpages, digital images, digital audio, digital video and multimedia content, documents, and so forth that is made available via the partner system 104. Suppose a user of the client device 106, for instance, interacts with the digital content 124 displayed via the partner system 104 to access a listing 114 managed by the principal system 102. The user is capable of sharing information about the digital content 124 and the listing 114, through the communication module 128 via the network 108 to other computing devices, including other client devices 106 or users, the principal system 102, or the partner systems 104.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

### Principal System—Restricted Offer Message

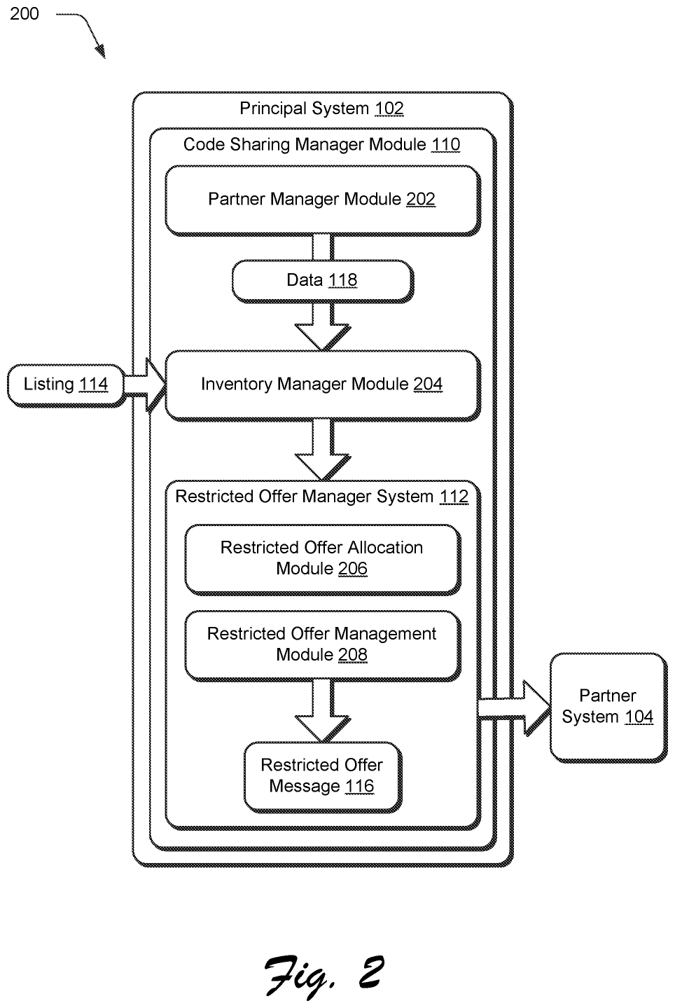

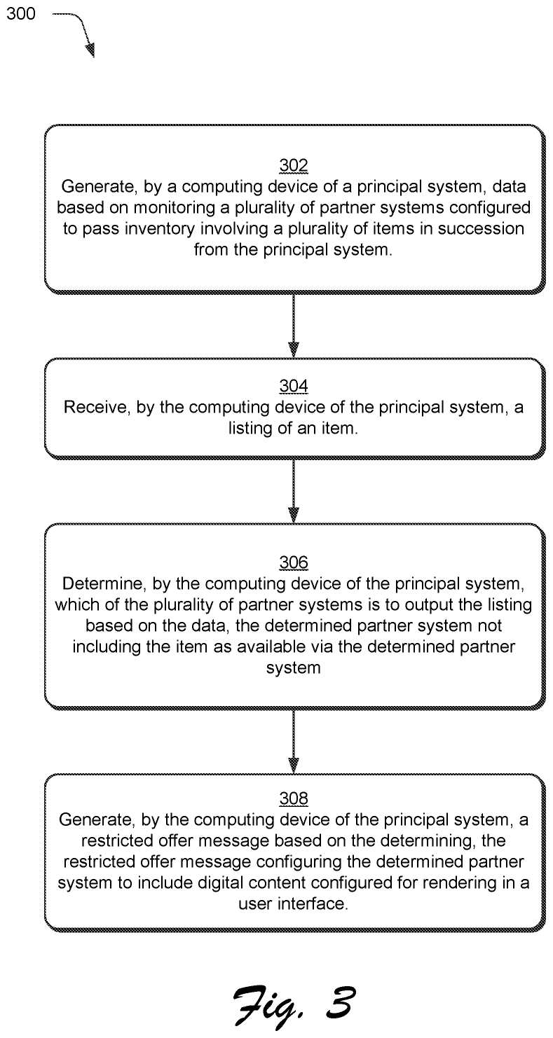

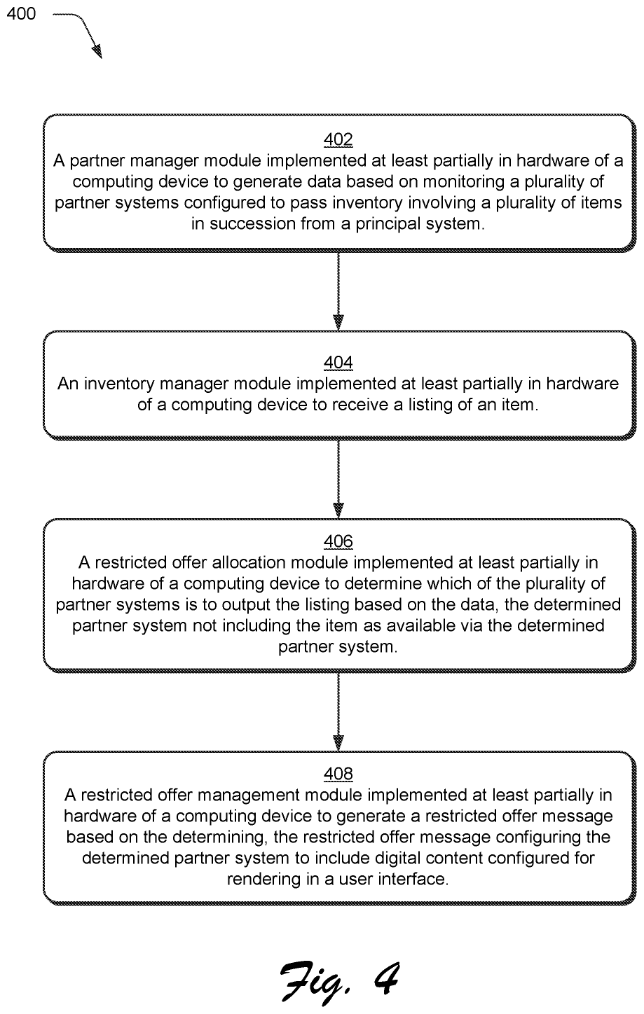

FIG. 2 depicts a system 200 in an example implementation showing operation of a principal system of FIG. 1 in greater detail as generating data based on monitoring a plurality of partner systems, and a restricted offer message. FIG. 3 depicts a procedure 300 in an example implementation in which a restricted offer message is generated based on determining which of the plurality of partner systems is to output a received listing of an item. The restricted offer message configures the determined partner system to include digital content configured for rendering in a user interface. FIG. 4 depicts a procedure 400 in an example implementation of a server system that may be operated by, on behalf, or under the control of a codeshare principal.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 2-4. In portions of the following discussion, reference to the principal system is made interchangeably with the server system.

To begin in this example, the principal system 102 generates, via a partner manager module 202, data 118 based on monitoring a plurality of partner systems 104 that are configured to pass inventory involving a plurality of items in succession from the principal system 102 (blocks 302 and 402). While monitoring the plurality of partner systems, the principal system 102 analyzes and monitors behavioral data, user data, partner data, and so forth, which may also be provided by the partner system as part of a code sharing arrangement. The monitoring of the plurality of partner systems may also involve partner-to-partner data. In one implementation, the partner systems 104 are structured in a hierarchy under the principal system 102. Generating data 118 based on the monitored activity enables the principal system 102 to better curate restricted code shares and listings 114 to be surfaced via the partner systems 104 in a codeshare arrangement.

In one example, data obtained from this monitoring is used as part of machine learning to train a model, e.g., a neural network. The model is trained using training data that describes user characteristics, characteristics of goods or services, characteristics of partner systems, and/or “where” in the hierarchy the goods or services are converted (e.g., by which partner system). The system, upon receipt of a new listing, may then make a determination in real time, even for items not previously encountered, using the trained model to determine where in the hierarchy of partners the item is to be made available as a restricted offer.

Over the course of ordinary business, principal systems 102 receive listings 114 of items that are added to its inventory, via an inventory manager module 204. By way of example, a principal system 102 may receive a new listing 114 for a respirator mask (blocks 304 and 404).

Based on the data 118 generated from monitoring the plurality of partner systems, the principal system 102 determines, via a restricted offer allocation module 206 of a restricted offer manager system 112, which of the plurality of partner systems is to output the listing 114, the determined partner system 104 not including the item as available (blocks 306 and 406), currently. The partner systems 104, for instance, may form a sequential hierarchical arrangement in which inventory is made available via different partner systems as a respective tier. Therefore, the principal system 102 may determine which hierarchical tier, and corresponding partner system 104, is to be provided with the listing 114.

For example, based on the data 118 generated from monitoring user behavioral activity, partner transactional history, and other types of data, the principal system 102 can determine that a specific partner system 104, such as a partner system 104 that primarily targets digital nomads, would be an appropriate partner system 104 to output the listing 114 of the respirator mask during a pandemic. Overall, the partner system 104 determined does not include the item as available via the determined partner system, such as on the partner's website, platform, and so forth. In the example scenario provided above, the partner system 102 for digital nomad consumers does not provide a respirator mask as an item; the item is otherwise inaccessible via the partner system 104. However, in view of a codeshare arrangement, the partner system 104 is enabled to output the relevant listing 114 of the item, and to make the listing 114 accessible as a limited or restricted offer, such as a one-time offer.

To facilitate the codeshare arrangement, the principal system 102 generates a restricted offer message 116, via a restricted offer management module 208, based on the determination of the partner system 102 that is to output the listing 114, the restricted offer message 116 configuring the determined partner system 104 to include digital content configured for rendering in a user interface, such as via a platform of a partner system 104, a client device, and so forth (block 308 and 408).

### Partner System—Restricted Offer Message

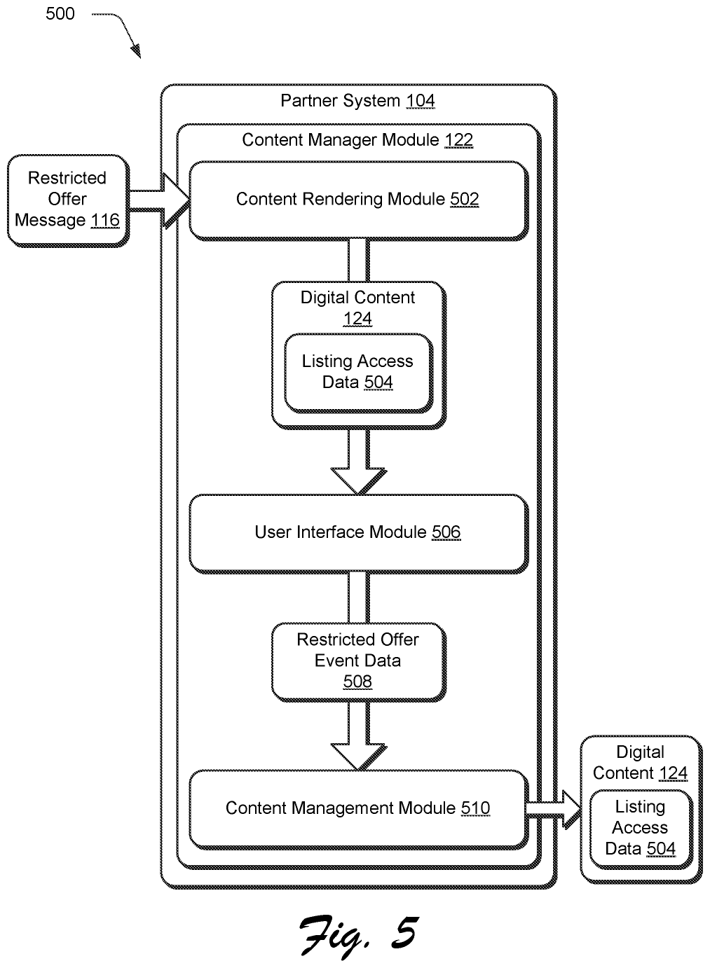

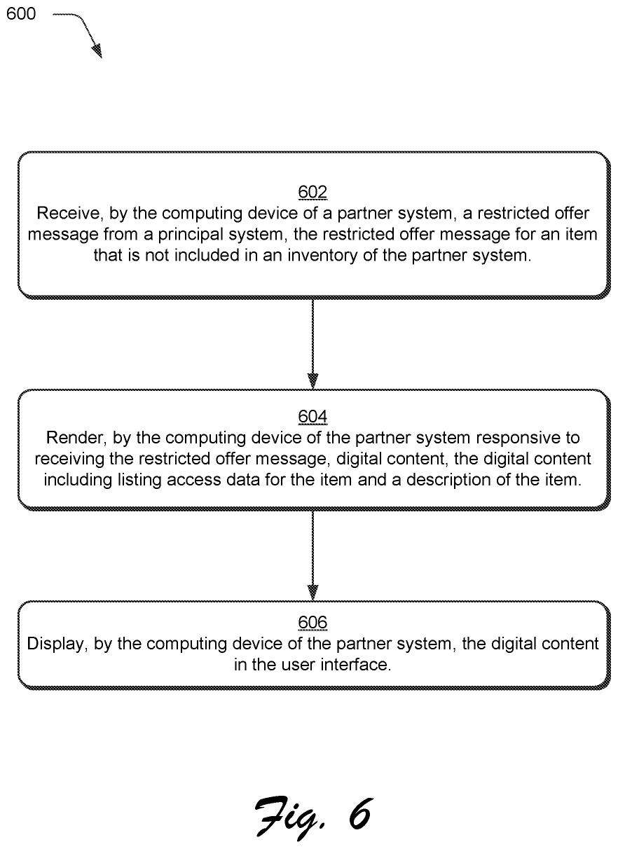

FIG. 5 depicts a system 500 in an example implementation showing operation of a partner system of FIG. 1 in greater detail. FIG. 6 depicts a procedure 600 in an example implementation in which a partner system renders digital content responsive to receiving a restricted offer message and displays the digital content in a user interface.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference is made interchangeably to FIGS. 5 and 6. In portions of the following discussion, reference to the principal system is made interchangeably with the server system.

To begin in this example, the partner system 104 receives, by a content manager module 122, a restricted offer message 116 from a principal system 102, the restricted offer message 116 for an item that is not included in an inventory of the partner system 104 (block 602). For instance, the item may be a respirator mask that is not included in an inventory of the partner system 104. One implementation of the restricted offer message 116 includes a unique item identifier for the listing of the item.

The partner system 104 then renders, via a content rendering module 502, responsive to receiving the restricted offer message 116, digital content 124, the digital content 124 including listing access data 504 for the item and a description of the item (block 604). The digital content 124, for instance, may be a digital image that promotes the listing of the item. Examples of the description of the item include a digital image of the item, a price of the item, and so forth. Examples of listing access data 504 include a URL, a QR code, and so forth. The listing access data 504 makes the listing of the item accessible to users, for example, via user selection of the digital content 124. The partner system 104 then displays, via a user interface module 506, the digital content in the user interface (block 606). When restricted offer event data 508 is received in regard to the listing, for example, due to conversion of the item by an end user, it is further processed via a content management module 510.

### Client Device—Restricted Offer Message

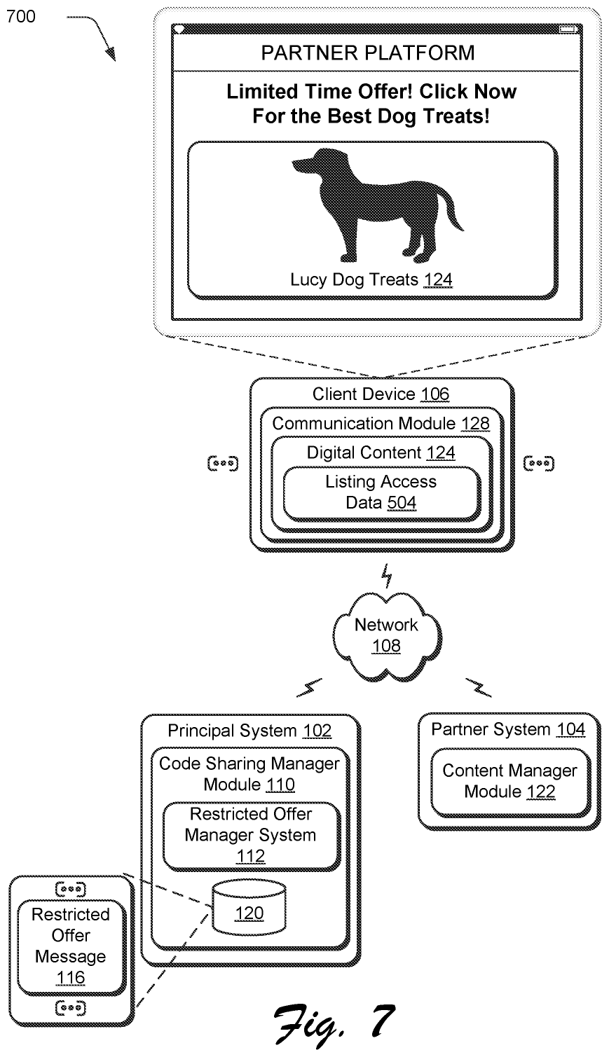

FIG. 7 depicts a system in an example implementation in which a client device receives, via a user interface displaying digital content, listing access data to access a listing of a restricted offer message.

The following discussion describes techniques that may be implemented utilizing the previously described systems and devices. Aspects of each of the procedures may be implemented in hardware, firmware, software, or a combination thereof. The procedures are shown as a set of blocks that specify operations performed by one or more devices and are not necessarily limited to the orders shown for performing the operations by the respective blocks. In portions of the following discussion, reference will be made to FIG. 7.

To begin in this example, digital content 124 including listing access data 504 is received by a communication module 128 of a client device 106. Next, the listing access data 504 of the digital content 124 is displayed via a user interface of the client device 106. This is depicted in the illustrated example of FIG. 7 as a selectable image link of a dog for “Lucy Dog Treats” that is displayed on a partner platform. Continuing with the illustrated example, user input may be received by the client device 106, by selecting the dog image link, the user input utilizing the linked URL to access a listing of the restricted codeshare (e.g., a purchase of Lucy Dog Treats) of the principal system 102. In one or more implementations, the listing is configured to receive user inputs supporting conversion (e.g., purchase) of a good or service of the listing. By way of example, a user may be able to purchase some dog treats that were promoted via the digital content 124 illustrated in FIG. 7.

Then, access to the listing 114 is received by the client device 106. By way of example, the client device 106 might receive access to a one-time purchase of Lucy Dog Treats. This receiving of access may be determined in various ways. For example, such a determination can be made by the principal system 102, the partner system 104, or the client device 106. The client device 106, or a computing device communicatively coupled to the client device 106, may communicate to the principal system 102 or the partner system 104 that conversion or access occurred. Responsive to a successful conversion, such as a purchase of an item of the listing of the restricted offer message, resources to complete the transaction may be allocated directly or indirectly to the principal system 102, the partner system 104, or some other intermediary system. The resource allocation of the transaction may be in various forms, such as fiat currency, cryptocurrency, and so forth. The resource allocation may be processed (e.g., payment processing) via transactional functions of the principal system. After accessing the listing via the listing access data, if there is no successful conversion, the listing may be configured to become unavailable for display by the client device 106 when the restricted offer message 116 is rescinded.

### Code Sharing Ecosystem

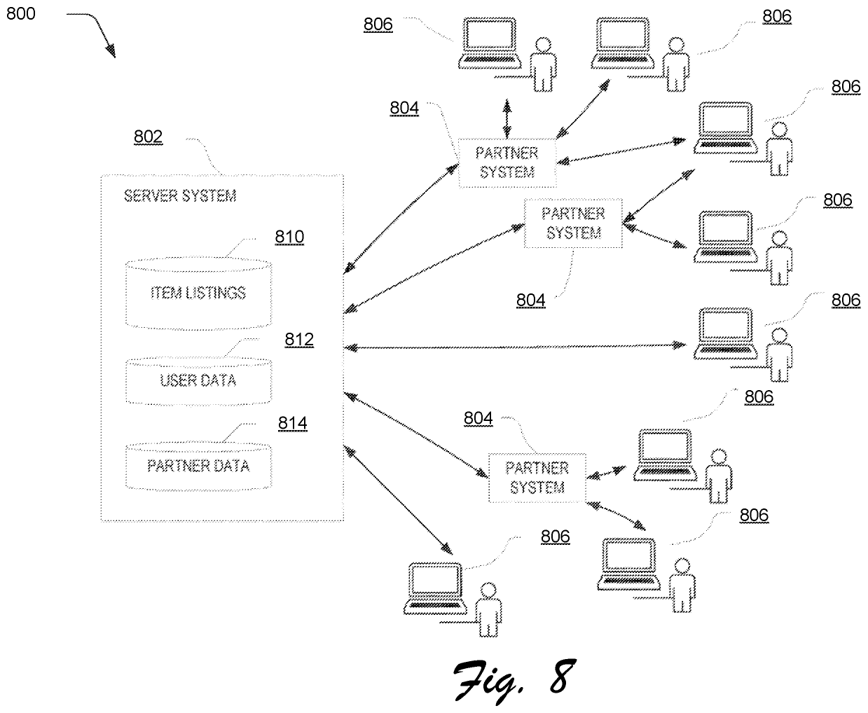

With reference now to the accompanying drawings, FIG. 8 illustrates, in block-diagram form, a code sharing ecosystem 800 according to example embodiments. Within the ecosystem 800, a server system 802 can interact, via the internet or some other suitable communications network (not shown), with one or more partner systems 804, which may, in turn, be accessed by one or more end users' client devices 806. Additionally, the server system 802 may interact directly with some end users via their client devices 806. For purposes of the following discussion, the server system 802 is operated by, on behalf, or under the control of a codeshare principal, whereas the partner systems 804 are operated by, on behalf, or under the control of respective codeshare partners.

The server and partner systems 802, 804 as well as the client devices 806 are implemented by suitable computing hardware including one or more computer processors, which may generally include any combination of general-purpose processors configured by program code stored in computer-readable media to perform the functionality described herein and/or hardwired or otherwise permanently configured special-purpose processors. In various embodiments, the server system 802 includes either a single server computer or multiple server computers communicating with each other via a suitable wired or wireless network, such as, for example and without limitation, a local area network (LAN) established by Ethernet cable or Wi-Fi connections between computers, or a wide area network (WAN), such as the internet, utilizing telephone lines, radio wave transmission, or optical fiber connections. Each of the one or more computers within the server system 802 may be implemented, e.g., with a machine. The partner systems 804 may likewise each be implemented by one computer or multiple computers intercommunicating via a network. Functionally, the partner systems 804 play the role of servers in relation to the client devices 806, but constitute clients vis-a-vis the server system 802. The client devices 806 employed by the end users are usually (although not necessarily) personal computers, such as desktop or laptop computers, tablets, smartphones, or the like. The server system 802, partner systems 804, and client devices 806 all include network interfaces to facilitate communications between them.

In accordance with various embodiments, the server system 802 may operate an e-commerce platform that lists products, services, and/or real estate available for purchase, rent/lease, auction, ordering, or reservation via online transactions. Equally, the server system 802 may implement search services such as search, digital media consumption, etc. In one embodiment, the codeshare principal may maintain a physical inventory of listed products, e.g., stored in warehouses operated by the codeshare principal, and/or may act simply as a sales intermediary for products offered by third-party sellers. Such third-party sellers may include commercial entities such as manufacturers, distributers, and retailers, as well as individual seller-users that list items on the e-commerce platform. Similarly, the providers of listed services may be employees of the codeshare principal, independent contractors, or unaffiliated third-party providers that use the e-commerce platform as a referral system. For each item listed, the server system 802 may store, e.g., in an item listings database 810, a unique item identifier along with an item description (including, e.g., a name/title, longer textual description or specification, one or more images) and price, and, optionally, seller/provider information, shipping options, customer reviews, or other pertinent information. The item listings are herein collective also referred to as the codeshare partner's “inventory.”

Examples of products that may be offered on the site-commerce platform include consumer products (such as, e.g., apparel, vehicles, toys, or consumer electronics) as well as industrial merchandize (such as, e.g., raw materials or device components). Examples of services include pure labor or professional services (such as, e.g., babysitting or accounting) as well as service tied to goods (e.g., landscaping, catering) or to the use of venues or facilities (e.g., flights, hotel accommodations), and may likewise be offered to private as well as business customers. Real estate may include, e.g., homes or vacation properties. As will be apparent from these examples, the terms “electronic site,” “products and/or services,” “item listings,” are intended to be accorded broad scope as to the specific applications they cover. Further, where the following description refers to a “purchase,” “sale,” or the like, it is to be understood that, unless otherwise indicated or clear from context, other transaction types (e.g., rent/lease, reservation, etc.) are also contemplated.

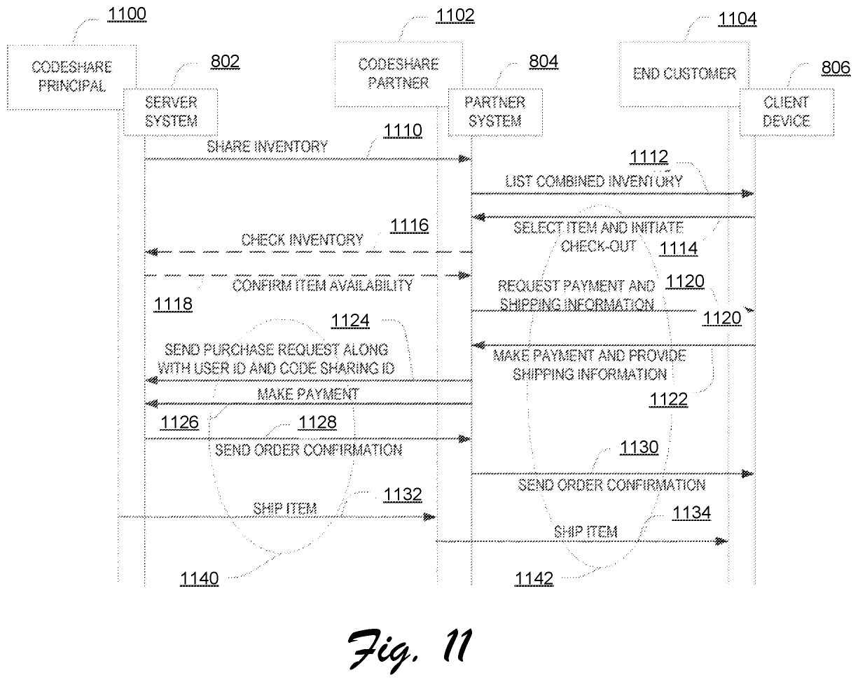

The e-commerce platform operated by the server system 802 may be accessed by end users (e.g., via client devices 806), who can directly purchase items (or place bids for items in an auction setting) on the platform. In addition, in accordance with various embodiments, partners 804, which may operate their own respective e-commerce platforms, can retrieve at least a portion of the inventory from the item listings database 810 of the server system 802 for integration into their own listings. End users can then transact for items from the codeshare principal's inventory with the partner system 804, which can, in turn, obtain the items on behalf of its customers from the principal using the server system 802. In this manner, the codeshare partners can round out and expand their offerings, while the codeshare principal gains access to the partners' customers. Details of such two-buyer transactions, in which the partner acts as the direct buyer and the end user constitutes an indirect buyer, are described below with respect to FIG. 11.

In addition to channeling sales through its partners, the code share principal can also enable the partners' systems 804 to enhance the user experience on their own respective platforms, and thereby possibly drive sales, by providing search and discovery tools for products/services the end user may be interested in. For example, instead of or in addition to pulling inventory information from the server system 802 upfront, a partner system 804 may send, based on a search query or other input from one of its users, a specific search request to the server system 802, and the server system 802 may respond with one or more listings identified within its inventory based on the request. Further, in response receipt, at the server system 802, of a search or purchase request sent by the partner system 804 on behalf of its user, the server system 802 may send recommendations for additional items of potential interest, e.g., as determined from statistical user purchase behavior (such as a determination that users who viewed or purchased one kind of item also displayed interest in another item, or an identification of best-selling items). In accordance with various embodiments, such search results, recommendations, and the like may be tailored to specific users and/or to characteristics of the codeshare partner. To facilitate tailored responses, the server system 802 may gather user data and partner data from the partner systems 104 (with consent) and store them as data records associated with unique user identifiers and/or code sharing identifiers in respective databases 812, 814. In various embodiments, each request sent by a partner system 804 for a particular user includes the respective user identifier and code sharing identifier, enabling user and partner behavior to be tracked by the server system 802 across transactions and communications.

One application of code sharing involves a codeshare partner operating in a particular niche market that may wish to complement its offerings by listing related products or services, and a codeshare principal interested in meeting the partner's need to thereby gain exposure to the partner's customers. For instance, a women's clothing boutique may also want to offer is customers shoes, jewelry, and/or other accessories that complement the apparel it sells. For this purpose, the boutique may obtain item listings in the shoes, jewelry, and accessories categories from the codeshare principal and incorporate them into its own online store, e.g., matching up items of clothing provided by the partner with complementary items available from the principal. The boutique's customer can then purchase both types of items through the boutique. In some instances, the customer may buy all items online In other situations, the customer may buy the boutique's core merchandize (e.g., clothing) physically in a brick-and-mortar store, and order the complementary item(s) on the store's website, mobile app, voice interface, phone ordering system, etc. The customer may, for instance, connect to the store's website, e.g., through a mobile application on her own device 806, while visiting the physical store. Alternatively, the store may have (store-owned) computer terminals, tablets, or the like available for its customers to use for the purpose of accessing its website. That is, a user may, in some circumstances, interact directly with the partner system 804 via user input/output devices, rather than indirectly over a network via a client device 806 owned by the user.

To provide yet another example that also covers the services sector, a codeshare principal may provide an online wedding planning platform that lists venues available for rental, caterers, musicians and other entertainment services, florists available for hire and/or specific flower arrangements available for purchase, wedding gowns, wedding rings, etc. To advertise its offerings and increase its market share, the codeshare principal may partner up with local venues, florists, caterers, and so on, which can integrate products and service listings in categories they do not themselves service to provide their customers with a one-stop shopping experience.

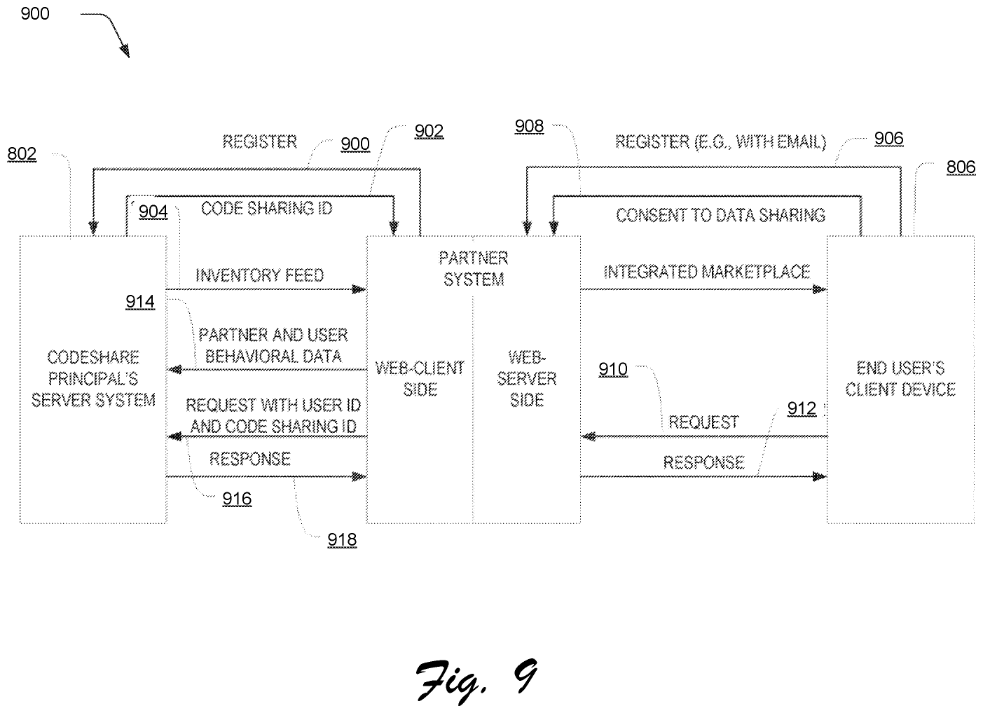

Turning now to FIG. 9, the communications between a codeshare principal, codeshare partner, and end user in accordance with various embodiments are illustrated in more detail. As shown, the partner system 804 may interact with the principal's server system 802 via web-client components, and with the end user's client device 806 via web-server components.

To facilitate interactions between the code-sharing parties, the partner system 804 is registered, at 900, with the principal's server system 802. The registration may involve setting up a partner profile that may specify, e.g., contact information (e.g., a corporate address, email and phone number of a liaison managing the code-sharing relationship), the partner's geographic market and/or area of business (including, e.g., categories of products or services the partner offers), categories of product or service listings that the partner is interested in receiving from the principal, expected sales volume of the principal's inventory on the partner system, financial account information (for the purpose of facilitating payments between the parties), etc. The registration may also include downloading application plug-ins, libraries, or other software components from the server system 802 to the partner system 804 to support various functionalities associated with the code-sharing arrangement. Further, in the course of the registration, the server system 802 may assign and communicate a code sharing identifier (code sharing ID) to the partner system 804 at 902. Alternatively, the code sharing ID may have been provided to the partner during the preceding establishment of contractual relations between the party, and may be entered by the partner during the registration of the partner system. Either way, in subsequent communications between the server system 802 and the partner system 804, the partner can identify itself by including the code sharing ID in its messages. Following registration, the partner system 804 may, at 904, receive inventory feeds, which may be tailored based on the partner profile, e.g., to include only listings within the specified categories of interest. The partner system 804 may merge these listings with other (e.g., its own) listings into an integrated listing on the partner's e-commerce platform.

On the other side of the partner system, certain interactions with the end user may be enabled by a user registration process at 906. As part of this process, the user may, e.g., create a username and password (or set up other authentication credentials), provide an email or telephone number (or similar personal information), and/or volunteer information concerning the user's interests and preferences, or other information that may enable the partner system to customize its communications to the user. To permit data sharing about the end user between the codeshare partner and principal in accordance herewith, the user registration process also involves obtaining, at 908, the user's affirmative consent to such information sharing. A request for consent may be made in conjunction with presenting the user with, and asking for his acknowledgement of, the partner's privacy policy and/or any applicable privacy laws. Prior to and/or along with being asked to allow information sharing with a third party (e.g., in this case, the codeshare principal), the user may also be informed that the partner system 804 would like to track the user's interactions with the partner's website or other platform (e.g., for the purpose of customizing dynamic website portions and/or improving the user experience) and asked for his affirmative consent to such tracking. Absent the requested consent, the user's actions are not tracked. Further, if the user consents to being tracked, but not to information being shared, the partner system 804 will refrain from forwarding tracked user data to the principal's server system 802. If the user does provide the requested consent, the user may be persistently reminded of the tracking and/or sharing, and given the opportunity to withdraw his consent, e.g., in a login screen or other portion of a website display sent by the partner system 804, or by periodically (e.g., weekly or monthly) sent electronic notifications or messages.

At 910, the partner system 804 provides the end user with access to its e-commerce platform, into which the inventory feed received from the principal's server system 802 is integrated. Via one or more request-response exchanges at 910, 912, the user can browse the platform, search for particular items, and/or purchase listed items (which may be digital or physical goods, services, viewing options, etc.), regardless of whether they originate from the codeshare principal or are part of the partner's own inventory (or a party, other than the codeshare principal, listing within the partner's platform). Assuming the requisite user consent has been given at 908, the partner system 804 may track all these interactions, aggregate them, and, at 914, pass them on as user behavioral data, along with a unique user identifier (user ID), to the server system 802. In addition to the user behavioral data of an individual user, the partner system 804 may also send partner behavioral data (along with the partner's code sharing ID) to the server system 802 at 914. Certain request received from the user may trigger the partner system 804 to send a corresponding request, along with the user ID and code sharing ID, to the server system 802 at 916. Such requests may include, e.g., a purchase request for items available from the codeshare principal, in response to which the server system 802 implements a phase of a transaction for the item, or s search request, to which the server system 802 may respond with search results tailored based on the user and/or partner behavioral data at 918, The user and partner behavioral data may also serve to update the inventory feed, e.g., to conform it to the evolving needs and preferences of the partner's customer base.

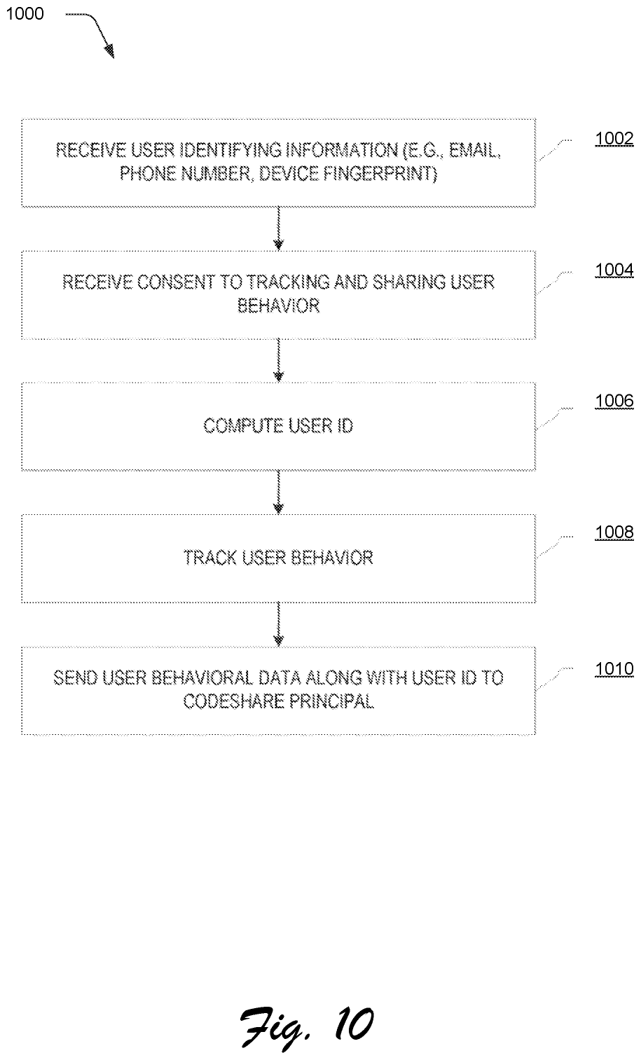

FIG. 10 is a flow chart depicting various acts of a method 1000 performed by the codeshare partner in furtherance of providing user behavioral data to the codeshare principal, in accordance with various embodiments. The method 1000 involves receiving, from the user, identifying information, such as an email address or telephone number (act 1002), as well as consent to tracking the user's behavior on the website (or within some other platform) and sharing user data with the codeshare principal (act 1004). As discussed above, the user's information and consent may be obtained as part of a registration process. It is, however, also possible that the user provides the information, and consent to share some user-specific data, during a guest-check-out process that does not require registration.

Following receipt of the user's consent, the partner system 804 generates a unique user ID (act 1006). The user ID may be based, e.g., on the user's email address or telephone number, or some other combination of information that is likely unique to the particular user (e.g., the user's name in conjunction with his mailing address). In some embodiments, the user ID is based on a device fingerprint of, and thus tied to, the particular client device 806 with which the user accesses the partner system 804. The device fingerprint may include, e.g., a media access control (MAC) or internet protocol (IP) address of the client device 806, the device serial number, or some unique combination of the device type and model (e.g., iPhone 8), a device description, detail of one or more applications installed on the device, device settings and/or configurations (e.g., a TCP/IP configuration, operating-system fingerprint, clock skew, etc.), or other classifiable or identifiable features. Methods for computing device fingerprints are generally known to those of ordinary skill in the art.

The user ID serves, in accordance herewith, to identify a given user to the codeshare principal consistently across transactions, allowing the principal to aggregate user data for the user. Identifying the user does, in this context, not necessarily mean that the user's real-world identify is revealed to the principal. In some embodiments, to the contrary, the user ID is some encoding, such as a hash, of the information (e.g., email address or device fingerprint) on which it is based. In this mariner, the user's privacy can be protected, while, at the same time, consistent use of the same encoding algorithm ensures that the user ID computed for a given user is always the same. In some embodiments, the algorithm by which the partner systems 804 compute user IDs is prescribed by the codeshare principal, and is consistent across different partners. As a result, user IDs will be consistent not only across transactions, but also across partners, allowing the principal to associate data received from different partners, but for the same user, with the same user data record or user profile. Note that prescribing the encoding algorithm does not necessarily enable the codeshare principal to decode the user ID. Hash functions, for example, may be practically non-invertible, such that the argument (e.g., an email address) cannot be reconstructed from the hash value.

With renewed reference to FIG. 10, the partner system 804 tracks the user's behavior on the partner platform (e.g., the partner site) and/or beyond (act 1008). Tracked behavioral data may include, e.g., click data (i.e., which item-listings or, more generally, web-page elements the user clicks on), broader browsing data (e.g., which pages or item listings the user views, and for how long, as may be gleaned, for instance, from tracked mouse-overs, scroll-throughs, etc.), purchase data (including, e.g., a list of purchased items and associated prices, total spending over a specified period, average spending per month or over some specified duration, fluctuations in spending over time, a break-down of purchased items by category, time of purchase, etc.), and combinations thereof (e.g., correlations between views of item listings and any resulting purchases). User behavioral data may also include data unrelated to interactions with the partner platform, such as usage of unrelated applications on the client device 806, user telemetry data such as, e.g., the user's location as determined from global positioning system (GPS) data (or other data obtained using physical sensors of the client device 806), communication patterns (e.g., the frequency of text message exchanges with the user's contacts), and others. The collection and analysis of such data may allow inferences about demographic characteristics (e.g., age, gender, income bracket, etc.), personal preferences (e.g., product types the user is most interested in), and routines/schedules (e.g., time spent online or off-line, time spent in transit as determined from GPS data) of the user. For example, the type of clothes a user browses may allow the user's gender to be determined, a user's regular purchase of toddler toys may indicate that the user has young children, book purchases may reveal the user's education level, and transitions between two locations that occur regularly in the morning and early-evening hours on weekdays may allow an inference that the user is employed. In accordance herewith, the benefit of such information is passed on to the codeshare principal when the partner, in act 1010, sends the user behavioral data, along with the associated user ID, to the principal.

Turning now to FIG. 11, the transactional flow of a two-buyer transaction in accordance with various embodiments is illustrated. The transaction involves the codeshare principal 1100, the codeshare partner 1102, and the end customer 1104. It is assumed, as a starting point, that the codeshare principal 1100 has shared at least a portion of its inventory via an inventory feed from the server system 802 to the partner system 804 (at 1110), and that the partner system 804 provides a combined inventory (including the listings from the shared inventory portion) to the end customer's client device 806 (at 1112). It is further assumed, for purposes of the illustrated example, that the contractual arrangement between the code-sharing parties is a “free-flow” codeshare, in which the partner buys from the principal on-demand in response to a purchase request from one of its users rather than purchasing some portion of the inventory upfront (as is the case in so-called block-space codeshare arrangements).

The transaction is initiated when the end customer 1104, using the client device 806, selects an item from the codeshare principal's inventory for purchase and begins the check-out process (at 1114). In response to this indication that the user wants to purchase the selected item (as reflected in a message from the user that specifies the item identifier), the partner system 804 may, optionally, transmit an inventory check including the item identifier to the server system 802 (at 1116), to which the server system 802 may respond with a lock status indicating whether or not the item is still available. As will be appreciated, such an inventory check is generally superfluous if the server system 802 sends real-time (or near real-time) inventory-feed updates to the partner system, allowing the partner system 804 to remove depleted inventory from its listings. If the server system 802 confirms (at 1118) that the item is available (or if the partner system 804 had an up-to-date inventory), the transaction can proceed.

At 1120, the partner system 804 requests payment and shipping information from the customer 1104. The customer 1104 provides the requested information at 1122, thereby paying for the item. Although not explicitly shown, payment may be facilitated and processed by a third-party payment service, such as a credit card company or online payment system. Upon processing of the customer's payment, the partner system 804 sends a purchase request for the item (specified by its associated item identifier) to the server system 802 (at 1124). The purchase request also includes the customer's user ID and the partner's code sharing ID, which allows the server system 802 to record the transaction in respective user and/or partner data records. The partner system 804 further transmits payment for the item at 1126. Again, payment may be facilitated via a third-party payment service, although the codeshare principal and partner may also establish more direct payment channels in view of large numbers of transactions they may engage in. Once payment for the item is made, the server system 802 sends an order confirmation to the partner system 804 (at 1128), and the partner system 804, in turn, sends an order confirmation to the client device 806 (at 1130). The server system 802 also arranges for shipment of the item, e.g., by sending a message internally to the principal's shipping department if the item is held in physical inventory of the principal 1100, and otherwise to an external seller, as the case may be. The item is shipped (from the principal 1100 or a third-party seller) to the codeshare partner (at 1132), and then forwarded by the codeshare partner to the end customer 1104 (at 1134).

Although the described transaction includes two interleaved transactional stages—a transaction stage 1140 in which the partner 1102 acts as a buyer purchasing from the principal 1100, and a transactional stage 1142 in which the partner 1102 acts as (re-)seller of the purchased item to the end customer—the end customer 1104 may be oblivious to the former stage, and thus experience only one transaction. From the codeshare principal's perspective, there are two buyers associated with the transaction: the partner 1102 and the end customer 1104.

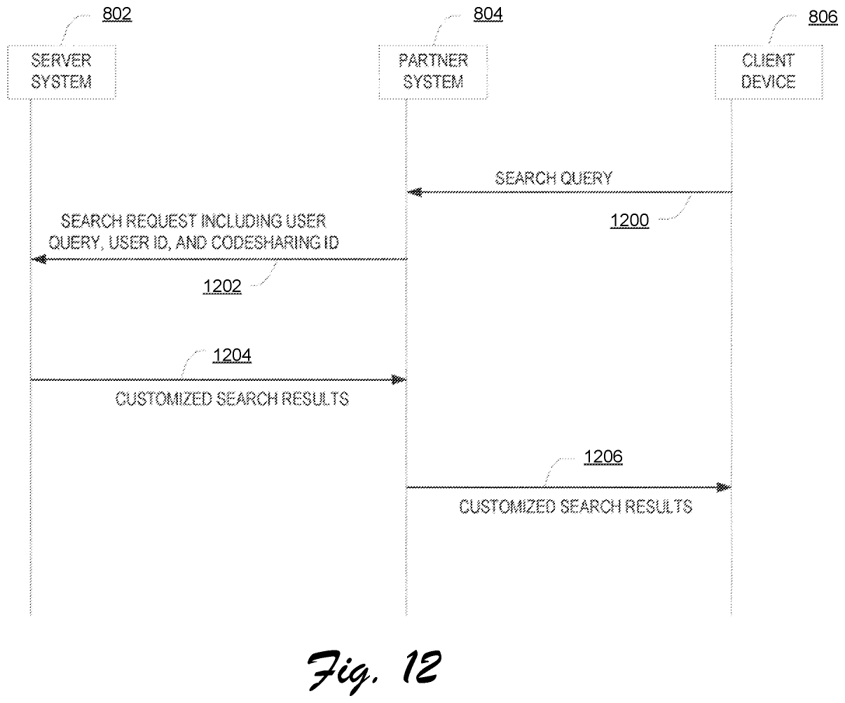

FIG. 12 depicts a partner-mediated informational flow between a codeshare principal and an end customer in accordance with various embodiments, providing an example of the principal enhancing the end user's experience on the partner's platform. In this flow, the client device sends a search query to the partner system (at 1200). The partner system 804 formulates and sends a corresponding search request to the server system 802 (at 1202). The request includes the query criteria included in the end user's request (e.g., one or more search terms specifying the type of product or service the user is looking for, and/or other criteria, such as a date by which the user needs the item delivered, an acceptable price range, etc.). In addition, the search request to the server system 802 includes the user ID) of the end user and the code sharing ID of the partner. The server system 802 uses this information to identify listings that not only satisfy the user query criteria, but are also customized to the user and/or partner. The server system 802 may, for instance, first retrieve item listings responsive to the query, and then filter the listings based on user and partner data records associated with the identifiers contained in the request. The filtering may, for instance, take user preferences as determined from the user's past browsing and/or purchase behavior into account, and/or may limit the items to one or more categories that the partner wishes to add to its own inventory. The filtered listings are returned to the partner system 804 and forwarded to the client device 806 as customized search results (at 1204, 1206).

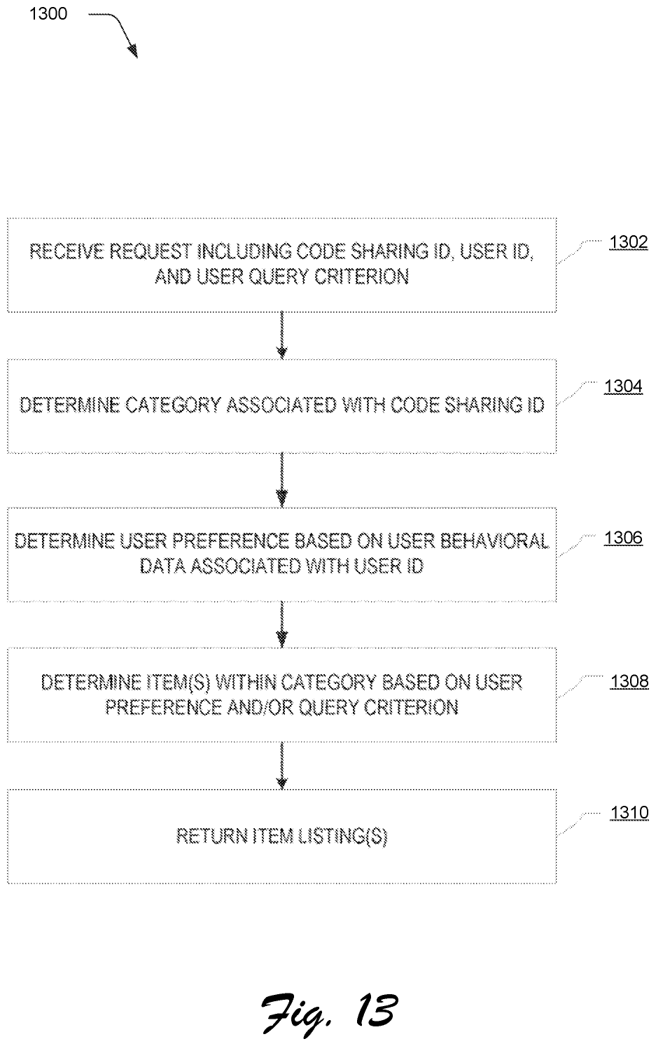

FIG. 13 is a flow chart of one example method 1300 performed by a codeshare principal's server system 802 in tailoring its response to a request based on user preferences, in accordance with various embodiments. The method 1300 begins, in act 1302, with the receipt of a request, e.g., from a codeshare partner's system 804, that includes a code sharing ID (e.g., the ID associated with that partner), a user ID (e.g., the ID associated with a user on behalf of whom the partner sent the request), and one or more user query criteria (e.g., as provided by the user to the partner system 804). The server system determines, in act 1304, a category associated with the code sharing ID. The category may be, e.g., a category or sub-category within a product taxonomy (e.g., vehicles, computers, mobile phone chargers), a particular brand that possibly covers multiple product categories (e.g., Apple™, which may refer, e.g., to Macintosh™ computers or iPhones™), or a group of products defined by some other set of criteria (e.g., release within the last year, manufacturing in a certain country, standard compliance, and so on). In some embodiments, the category (or categories) associated with the code sharing ID specifies the kinds of product listings that the partner would like to get from the principal for inclusion into its own site or platform.

From the user ID specified in the request, the server system 802 determines user preferences, e.g., by looking up and analyzing user behavioral data stored in association with the user ID (act 1306). The system then identifies, in, for example, its item listings database 810, one or more items that satisfy the user preference and meet the user query criteria, and that moreover fall within the determined category (act 808). In some embodiments, this act is a two-step process in which items are first identified based on the preference associated with the user identifier and the user query criterion or criteria, regardless of category, and an item within the category is then selected from the identified items. For example, if at least two items match the user query criteria and general user preferences, and if further, at least one of the two or more items is associated with the category and at least one of the two items is not associated with the category, one or more item(s) associated with the category may be selected. The selected item listing(s) are then returned as the search results (act 1310). In some embodiments, the results are ranked based on the code sharing identifier, the user identifier, the user query criteria, or any combination thereof.

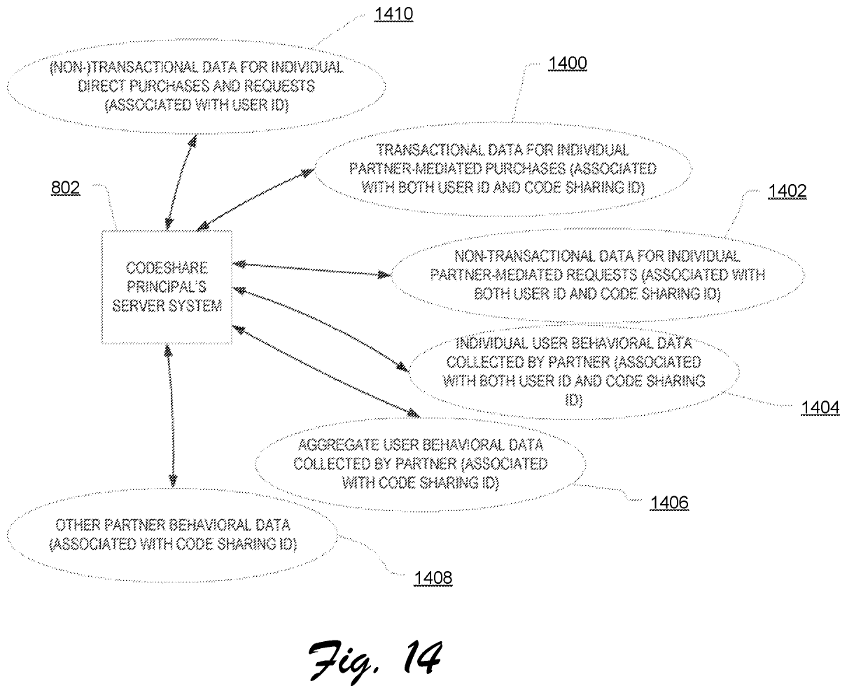

FIG. 14 is a schematic diagram illustrating various sources of user and partner behavioral data as can be used by a codeshare principal to tailor its responses to requests. As shown, transactional data for individual purchases mediated by a partner (1400), e.g., as illustrated in FIG. 11, constitute one source of information. The transactional data may include, e.g., a description and price of the purchased item, or other information known to the principal's system from the action itself (and not requiring further data from the partner), and since it is associated with both a user ID and a code sharing ID, it can form part of both user behavioral data and partner behavioral data. Non-transactional data for individual partner-mediated requests (1402), that is, pure information requests (e.g., search requests or requests for recommendations) that are not part of a purchase, as illustrated in FIG. 12, provide another source of information to the codeshare principal, and likewise form part of both user behavioral data and partner behavioral data. A third category of information associated with both a user and a partner is individual user behavioral data collected by the partner (1404), which includes information about transactions and requests that do not pertain to the principal's inventory and of which the principal would, therefore, not have any knowledge but for the data feeds from the partner pursuant to the codeshare agreement. The user behavioral data may include browsing and/or purchasing histories resulting from aggregating transactions and requests over time, as well as other information (e.g., telemetry data) described above with respect to FIG. 10.

The partner may also aggregate user behavioral data over its customer base to obtain statistical information (1406), such as average user spending, number of views and associated conversion rates for various listings or types/categories of products, and similar metrics. In as much as such information is associated with a particular codeshare partner, but not with a particular user, it can be regarded partner behavioral data rather than user behavioral data. Partner behavioral data may also include, as another type 1408, data that is unrelated to user behavior on the partner's platform, and instead captures the activities of the partner itself. Examples include information about the way in which the partner integrates the principal's inventory (e.g., the fraction of listings on the partner platform that come from the principal's inventory, the location, size, and other display attributes of the principal's listings) and metrics for the partner's efficiency in marketing the principal's offering (e.g., total sales volume for the principal's products).

On the other end of the spectrum, the codeshare principal may also obtain user behavioral data based on direct transactions with and (non-transactional) requests from users (1410). If user IDs are consistently assigned, user behavioral data may be aggregated across transactions/requests (e.g., involving a single codeshare partner as intermediary), across multiple partners (e.g., multiple websites through which the user purchases products), as well as across partner-mediated and direct transactions/requests, resulting in a comprehensive user data record associated with a unique user.

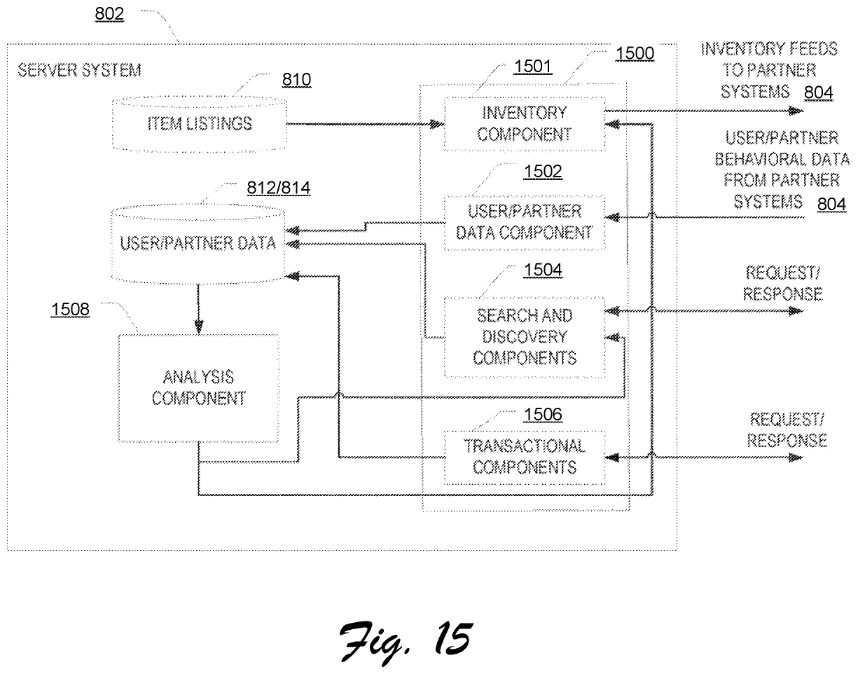

With reference now to FIG. 15, various components of a server system 802 providing the functionality described herein are illustrated. The server system 802 may include a code sharing component 1500 through which the system 802 interacts with partner systems 804. The code sharing component 1500 may include a communication (e.g., web site) component that communicates with a partner platform (e.g., the partner site). Equally, the code sharing component 1500 may include or interact with other components that perform operations to provide functionality to the partner platform. For example, a code sharing component 1500 may include, or interact with, an inventory component 1501 that pulls listings from the item listings database 810 and provides inventory feeds to the partner systems 804, a user/partner data component 1502 that receives user/partner behavioral data from the partner systems 804 and processes the data as needed for storage in the user and partner databases 812, 814, one or more search/discovery components that provide search results, recommendations, and the like to the partner systems 804 in response to requests and write related information to the user/partner databases 812, 814, and one or more transactional components that handle transactional request/response interactions (including, e.g., payment and shipment logistics) with the partner systems 804 and store the transactional information in the user/partner databases 812, 814. The server system 802 may also include an analysis component 1508 that may analyze the user and partner data records in the user/partner databases 812, 814 individually or collectively/statistically, and, based on the analysis, provide inputs that control the operation of the inventory component (e.g., by causing inventory feed adjustments) and the search/discovery components 1504 (e.g., by tailoring results). The analysis component 1508 may, for instance, discover buyer behavioral trends correlated with buyer characteristics discernible from multiple user data records taken in conjunction. It is to be appreciated that the code sharing component 1500 may include or interact with other components for other web applications; for example, in the case of a digital media site, it may focus on restricting content to a genre of interest. In the case of a search site, it may restrict search results to a partner site based on geography of the user.

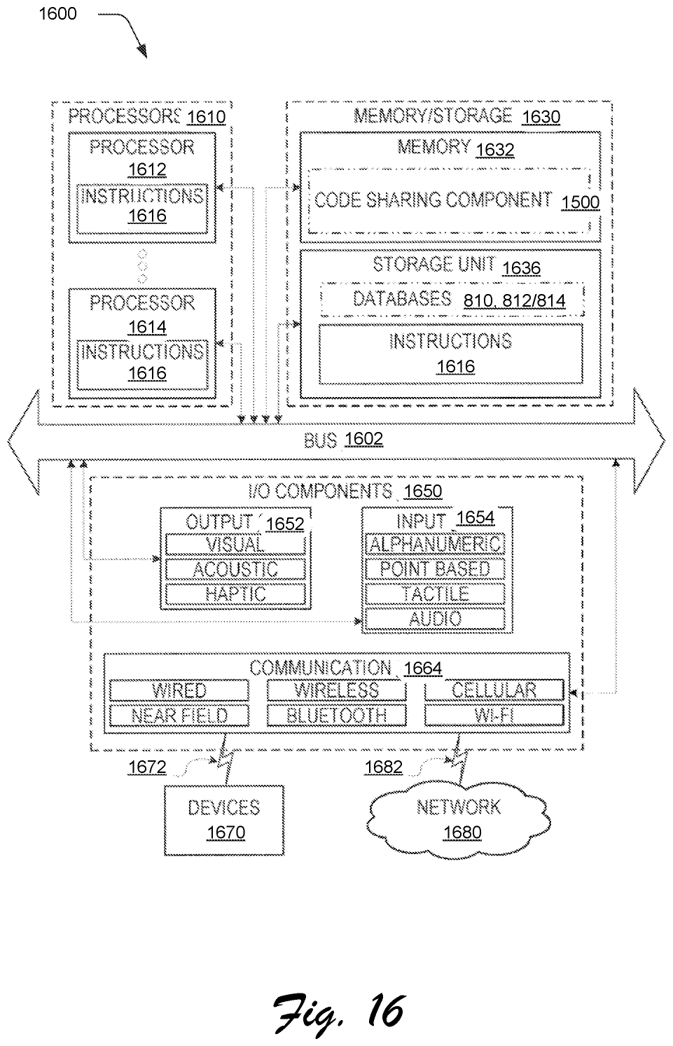

FIG. 16 shows a diagrammatic representation of a machine 1600 in the example form of a computer system within which instructions 1616 (e.g., software, a program, an application, an applet, an app, or other executable code) for causing the machine 1600 to perform any one or more of the methodologies discussed herein may be executed. The machine 1600 may, for example, implement any of the server system 802, partner systems 804, or client devices 1806. The instructions 1616 may cause the machine 1600 to execute any of the methods illustrated in the preceding figures. The instructions 1616 transform the general, non-programmed machine into a particular machine programmed to carry out the described and illustrated functions in the manner described. By way of example only, dash-dotted boxes indicate the machine 1600 as implementing the server system 802.

In various embodiments, the machine 1600 operates within a network through which it is connected to other machines. In a networked deployment, the machine 1600 may operate in the capacity of a server machine or a client machine in a server-client network environment, or as a peer machine in a peer-to-peer (or distributed) network environment. The machine 1600 may comprise, but not be limited to, a server computer, a client computer, a personal computer (PC), a tablet computer, a laptop computer, or other computer capable for use as any of the actors within the monitoring system described herein. Further, while only a single machine 1600 is illustrated, the term “machine” shall also be taken to include a collection of machines 1600 that individually or jointly execute the instructions 1616 to perform any one or more of the methodologies discussed herein.

The machine 1600 may include processors 1610, memory 1630, and I/O components 1650, which may be configured to communicate with each other such as via a bus 1602. In an example embodiment, the processors 1610 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, processor 1612 and processor 1614 that may execute instructions 1616. The term “processor” is intended to include multi-core processor that may comprise two or more independent processors (sometimes referred to as “cores”) that may execute instructions contemporaneously. Although FIG. 16 shows multiple processors 1610, the machine 1600 may include a single processor with a single core, a single processor with multiple cores (e.g., a multi-core process), multiple processors with a single core, multiple processors with multiples cores, or any combination thereof.

The memory/storage 1630 may include a memory 1632, such as a main memory, or other memory storage, and a storage unit 1636, both accessible to the processors 1610 such as via the bus 1602. The storage unit 1636 and memory 1632 store the instructions 1616 embodying any one or more of the methodologies or functions described herein. The instructions 1616 may also reside, completely or partially, within the memory 1632, within the storage unit 1636, within at least one of the processors 1610 (e.g., within the processor's cache memory), or any suitable combination thereof, during execution thereof by the machine 1600. Accordingly, the memory 1632, the storage unit 1636, and the memory of processors 1610 are examples of machine-readable media. When configured as the server system 802, the memory 1632 and/or storage unit 1636 may, for instance, store the item listings database and user/partner databases 812, 814, as well as instructions implementing the code-sharing component 1500.

As used herein, “machine-readable medium” means a device able to store instructions and data temporarily or permanently and may include, but is not be limited to, random-access memory (RAM), read-only memory (ROM), buffer memory, flash memory, optical media, magnetic media, cache memory, other types of storage (e.g., Erasable Programmable Read-Only Memory (EEPROM)) and/or any suitable combination thereof. The term “machine-readable medium” should be taken to include a single medium or multiple media (e.g., a centralized or distributed database, or associated caches and servers) able to store instructions 1616. The term “machine-readable medium” shall also be taken to include any medium, or combination of multiple media, that is capable of storing instructions (e.g., instructions 1616) for execution by a machine (e.g., machine 1600), such that the instructions, when executed by one or more processors of the machine 1600 (e.g., processors 1610), cause the machine 1600 to perform any one or more of the methodologies described herein. Accordingly, a “machine-readable medium” refers to a single storage apparatus or device, as well as “cloud-based” storage systems or storage networks that include multiple storage apparatus or devices. The term “machine-readable medium” excludes signals per se. The terms “client” and “server” each refer to one or more computers—for example, a “server” may be a cluster of server machines.

An implementation of the described modules and techniques may be stored on or transmitted across some form of computer-readable media. The computer-readable media may include a variety of media that may be accessed by the machine 1600. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

The I/O components 1650 may include a wide variety of components to receive input, provide output, produce output, transmit information, exchange information, and so on. The specific I/O components 1650 that are included in a particular machine will depend on the type of machine. For example, portable machines such as mobile phones will likely include a touch input device or other such input mechanisms, while a headless server machine will likely not include such a touch input device. It will be appreciated that the I/O components 950 may include many other components that are not shown in FIG. 16. The I/O components 1650 are grouped according to functionality merely for simplifying the following discussion and the grouping is in no way limiting. In various example embodiments, the I/O components 1650 may include output components 1652 and input components 1654. The output components 1652 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1654 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location and/or force of touches or touch gestures, or other tactile input components), audio input components (e.g., a microphone), and the like.

Communication may be implemented using a wide variety of technologies. The I/O components 1650 may include communication components 1664 operable to couple the machine 1600 to a network 1680 or devices 1670 via coupling 1682 and coupling 1672 respectively. For example, the communication components 1664 may include a network interface component or other suitable device to interface with the network 1680. In further examples, communication components 1664 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1670 may be another machine or any of a wide variety of peripheral devices (e.g., a peripheral device coupled via a Universal Serial Bus (USB)).

In various example embodiments, one or more portions of the network 1680 may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, the network 1680 or a portion of the network 1680 may include a wireless or cellular network and the coupling 1682 may be a Code Division Multiple Access (CDMA) connection, a Global System for Mobile communications (GSM) connection, or other type of cellular or wireless coupling. In this example, the coupling 1682 may implement any of a variety of types of data transfer technology, such as Single Carrier Radio Transmission Technology (1.times.RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard setting organizations, other long range protocols, or other data transfer technology.

The instructions 1616 may be transmitted or received over the network 1680 using a transmission medium via a network interface device (e.g., a network interface component included in the communication components 1664) and utilizing any one of a number of well-known transfer protocols (e.g., hypertext transfer protocol (HTTP)). Similarly, the instructions 1616 may be transmitted or received using a transmission medium via the coupling 1672 (e.g., a peer-to-peer coupling) to devices 1670. The term “transmission medium” shall be taken to include any intangible medium that is capable of storing, encoding, or carrying instructions 1616 for execution by the machine 1600, and includes digital or analog communications signals or other intangible medium to facilitate communication of such software.

The following numbered examples are illustrative embodiments of the disclosed subject matter.

1. A method performed by a server system, the method comprising: receiving a request, the request comprising a code sharing identifier associated with a partner, a user identifier, and a user query criterion; and, in response to the request: determining a category associated with the code sharing identifier; determining an item within the category based on a preference associated with the user identifier and the user query criterion; and returning the item in a response to the request.

2. The method of example 1, wherein determining an item within the category based on a preference associated with the user identifier and the user query criterion comprises determining two or more items based on the preference associated with the user identifier and the user query criterion, at least one of the two or more items being associated with the category and at least one of the two or more items not being associated with the category, and selecting, among the two or more items, an item associated with the category.

3. The method of example 1 or example 2, wherein the response comprises a ranking or recommendation of one or more items based on the code sharing identifier.

4. The method of any of examples 1-3, wherein the response comprises a ranking or recommendation of one or more items based on both the code sharing identifier and the user identifier.

5. The method of any of examples 1-4, further comprising receiving, prior to the request, a call that includes user behavioral data about a user associated with the user identifier, the user behavioral data collected at a partner platform associated with the code sharing identifier, wherein the preference associated with the user identifier is based at least in part on the user behavioral data.

6. The method of example 5, wherein the user behavioral data includes any one of: user click data, user telemetry data, or user browse data on a partner site.

7. The method of any of examples 1-6, further comprising receiving, prior to the request, a call that includes partner behavioral data about the partner associated with the code sharing identifier, wherein the item within the category is determined further based on the partner behavioral data.

8. The method of example 7, wherein the partner behavioral data includes any one of: aggregate behavioral data about multiple users on a partner platform, marketing data about a presentation of items received by the partner from the server system on the partner platform, or partner sales data for items within the category and for items outside the category.

9. The method of any of examples 1-8, wherein the user identifier is based on a device fingerprint of a device, and the device fingerprint includes a device description and detail of an application installed on the device.

10. The method of any of examples 1-9, wherein the user identifier comprises an encoding of at least one of an email address of a user associated with the user identifier, a phone number of the user, or a device fingerprint of a device, and wherein the encoding comprises a hash of the at least one of an email address of the user, a phone number of the user, or a device fingerprint.

11. The method of any of examples 1-10, wherein the code sharing identifier is based on a device fingerprint from a partner system.

12. A server comprising: one or more hardware processors; and one or more computer-readable media storing instructions that cause the processor to perform operations comprising: receiving a request, the request comprising a code sharing identifier associated with a partner, a user identifier, and a user query criterion; and, in response to the request: determining a category associated with the code sharing identifier; determining an item within the category based on a preference associated with the user identifier and the user query criterion; and returning the item in a response to the request.

13. The server of example 12, wherein determining an item within the category based on a preference associated with the user identifier and the user query criterion comprises determining two or more items based on the preference associated with the user identifier and the user query criterion, at least one of the two or more items being associated with the category and at least one of the two or more items not being associated with the category, and selecting, among the two or more items, an item associated with the category.

14. The server of example 12 or example 13, wherein the operations further comprise receiving, prior to the request, a call that includes user behavioral data about a user associated with the user identifier, the user behavioral data collected at a partner site associated with the code sharing identifier, wherein the preference associated with the user identifier is based at least in part on the user behavioral data.

15. The server of example 14, wherein the user behavioral data includes any one of: user click data, user telemetry data, or user browse data on a partner site.

16. The server of any of examples 12-15, wherein the operations further comprise receiving, prior to the request, a call that includes partner behavioral data about the partner associated with the code sharing identifier, wherein the item within the category is determined further based on the partner behavioral data.

17. The server of example 16, wherein the partner behavioral data includes any one of: aggregate behavioral data about multiple users on a partner platform, marketing data about a presentation of items received by the partner from the server system on the partner platform, or partner sales data for items within the category and for items outside the category.

18. The server of any of examples 12-17, wherein the user identifier is based on a device fingerprint of a device, and the device fingerprint includes a device description and detail of an application installed on the device.

19. The server of any of examples 12-18, wherein the user identifier comprises an encoding of at least one of an email address of a user associated with the user identifier, a phone number of the user, or a device fingerprint of a device.

20. One or more computer-readable media storing instruction which, when executed by one or more hardware processors of a machine, cause the machine to perform operations comprising: receiving a request, the request comprising a code sharing identifier associated with a partner, a user identifier, and a user query criterion; and, in response to the request: determining a category associated with the code sharing identifier; determining an item within the category based on a preference associated with the user identifier and the user query criterion; and returning the item in a response to the request.

Although the inventive subject matter has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

### Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. A method implemented by a computing device of a principal system, the method comprising:
generating, by the computing device, data based on monitoring a plurality of partner systems configured to pass inventory involving a plurality of items in succession from the principal system;
receiving, by the computing device, a listing of an item;
determining, by the computing device, which of the plurality of partner systems is to output the listing based on the data, the determined partner system not including the item as available via the determined partner system; and
generating, by the computing device, a restricted offer message based on the determining, the restricted offer message configuring the determined partner system to include digital content configured for rendering in a user interface.

2. The method as described in claim 1, wherein the restricted offer message is a one-time offer message.

3. The method as described in claim 1, further comprising receiving, by the computing device, a notification of an event associated with the restricted offer message.

4. The method as described in claim 3, wherein receiving the notification initiates one of:
configuring the determined partner system to make the digital content unavailable for rendering in the user interface; or
providing attribution to the determined partner system.

5. The method as described in claim 1, wherein the data comprises at least one of subscription data, curation data, impression data, conversion data, user behavioral data, or selection data.

6. The method as described in claim 1, wherein the digital content is selectable to access the listing of the restricted offer message.

7. The method as described in claim 1, further comprising:
receiving, by the computing device, a purchase request for the item;
processing, by the computing device, the purchase request; and
rescinding, by the computing device, the restricted offer message.

8. The method as described in claim 7, wherein the purchase request includes a code sharing identifier.

9. A method implemented by a computing device of a partner system, the method comprising:
receiving, by the computing device, a restricted offer message from a principal system, the restricted offer message for an item that is not included in an inventory of the partner system;
rendering, by the computing device responsive to receiving the restricted offer message, digital content, the digital content including listing access data for the item and a description of the item;
displaying, by the computing device, the digital content in the user interface.

10. The method as described in claim 9, wherein the restricted offer message is a one-time offer message.

11. The method as described in claim 9, wherein the digital content is selectable to make a listing of the item accessible.

12. The method as described in claim 9, further comprising receiving, by the computing device, a notification of an event associated with the restricted offer message.

13. The method as described in claim 12, wherein the partner system, responsive to receiving the notification:
makes the digital content unavailable for display in the user interface; or
transmits a purchase request to the principal system.

14. The method as described in claim 9, wherein the purchase request includes a code sharing identifier.

15. The method as described in claim 9, further comprising:
receiving, by the computing system, an indication of a conversion of the item;
generating, responsive to receiving the indication by the computing system, the purchase request; and
transmitting, by the computing device, the purchase request to the principal system.

16. The method as described in claim 9, further comprising:
receiving, by the computing system of the partner system, an indication of no conversion of the item; and
making, by the computing system, the digital content unavailable for display in the user interface.

17. A system comprising:
a partner manager module implemented at least partially in hardware of a computing device to generate data based on monitoring a plurality of partner systems configured to pass inventory involving a plurality of items in succession from a principal system;
an inventory manager module implemented at least partially in hardware of a computing device to receive a listing of an item;
a restricted offer allocation module implemented at least partially in hardware of a computing device to determine which of the plurality of partner systems is to output the listing based on the data, the determined partner system not including the item as available via the determined partner system; and
a restricted offer management module implemented at least partially in hardware of a computing device to generate a restricted offer message based on the determining, the restricted offer message configuring the determined partner system to include digital content configured for rendering in a user interface.

18. The system as described in claim 17, wherein the digital content is configured to be selectable to access the listing of the item.

19. The system as described in claim 17, wherein the data is generated based on monitoring user behavioral data.

20. The system as described in claim 17, wherein the restricted offer management module further comprises being implemented at least partially in hardware of a computing device to:
receive a purchase request for the item, the purchase request including a code sharing identifier;
process the purchase request; and
rescind the restricted offer message.
